(19) United States
(12) Patent Application Publication
(10) Pub. No.: US 2025/0267460 A1
(43) Pub. Date: Aug. 21, 2025

(54) METHOD AND APPARATUS FOR MANAGING A MOBILE EMBEDDED SECURITY PLATFORM

(71) Applicant: Telefonaktiebolaget LM Ericsson (publ), Stockholm (SE)

(72) Inventors: Giuseppe BURGARELLA, Dublin, CA (US); Massimiliano MAGGIARI, Pleasanton, CA (US); Wassim Michel HADDAD

(73) Assignee: Telefonaktiebolaget LM Ericsson (publ), Stockholm (SE)

(21) Appl. No.: 18/856,602

(22) PCT Filed: Jan. 26, 2023
(86) PCT No.: PCT/IB2023/050692

§ 371 Date: Oct. 11, 2024

Related U.S. Application Data
(60) Provisional application No. 63/331,719, filed on Apr. 15, 2022.

(51) Int. Cl. H04W 12/30; H04W 8/20; H04W 12/0471; H04W 12/06; H04W 12/50; H04W 60/04

(52) U.S. Cl. CPC H04W 12/35; H04W 8/20; H04W 12/0471; H04W 12/06; H04W 12/50; H04W 60/04

(57) ABSTRACT

A method performed by a computer-implemented controller is provided. The method includes receiving a request for managing one or more user equipments (UEs); obtaining a user-specific security profile from a first service provider; obtaining a subscriber identity module (SIM) profile from a network node or a second service provider; obtaining a set of secure access service edge (SASE) instances from the network node; building one or more UE-specific bootstrap configurations based on the user-specific security profile, the SIM profile, and the set of SASE instances; and sending the one or more UE-specific bootstrap configurations to a third service provider. The one or more UE-specific bootstrap configurations are obtainable by the one or more UEs to establish a secured wireless communication channel through a zero-trusted network.

### CROSS REFERENCE TO RELATED APPLICATION

This application claims priority to U.S. Provisional Patent Application No. 63/331,719 filed on Apr. 15, 2022, titled “METHOD AND APPARATUS FOR MANAGING A MOBILE EMBEDDED SECURITY PLATFORM (MESYP),” the content of which is hereby incorporated by reference in its entirety for all purposes.

### FIELD

The present disclosure relates generally to communication systems and, more specifically, to methods and systems for managing a mobile embedded security platform (MESyP) for establishing secured corporate communications over public and/or private wireless or mobile networks.

### BACKGROUND

Remote users rely on virtual private network (VPN) technologies to access corporate information technology (IT) services. For this purpose, VPN tunnels are setup between users' devices (e.g., a laptop, a tablet, a terminal device, and user equipment (UE)) and remote dedicated VPN gateways (GWs). VPN GWs are deployed behind corporate firewall(s). In such a configuration, it is difficult for the corporate IT department to obtain desired visibility into remote users' activities. That is, the IT department has difficulty in obtaining the same level of visibility as when the users (e.g., corporate employees) are working in office.

In order to improve visibility into remote-working users' activities, an IT department often collects logs from different corporate applications. Collecting logs from different applications may not be an easy task. Furthermore, from IT department's perspective, it is desirable to have dynamic granular access control with respect to different users, different applications, different times, and different locations. For example, the IT department may want to dynamically control over “who can access what and possibly from where and when”.

### SUMMARY

Various computer-implemented systems, methods, and articles of manufacture for relaxing radio resource management (RRM) measurements are described herein.

In one embodiment, a method performed by a computer-implemented controller is provided. The method includes receiving a request for managing one or more user equipments (UEs): obtaining a user-specific security profile from a first service provider: obtaining a subscriber identity module (SIM) profile from a network node or a second service provider: obtaining a set of secure access service edge (SASE) instances from the network node: building one or more UE-specific bootstrap configurations based on the user-specific security profile, the SIM profile, and the set of SASE instances; and sending the one or more UE-specific bootstrap configurations to a third service provider. The one or more UE-specific bootstrap configurations are obtainable by the one or more UEs to establish a secured wireless communication channel through a zero-trusted network.

In one embodiment, a method performed by a user equipment is provided. The method includes connecting to a wireless network. The method further includes, upon connecting to the wireless network, obtaining one or more UE-specific bootstrap configurations from a mobile device management (MDM) service provider. The one or more UE-specific bootstrap configurations are based on a user-specific security profile, a subscriber identity module (SIM) profile, and a set of SASE instances. The method further includes obtaining user credentials; and establishing, based on the one or more UE-specific bootstrap configurations, the user credentials, and the SIM profile, a secured wireless communication channel with a network node through a zero-trusted network.

Embodiments of a UE, a network node, and a wireless communication system are also provided according to the above method embodiments.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an exemplary wireless network in accordance with some embodiments.

FIG. 2 illustrates an exemplary user equipment in accordance with some embodiments.

FIG. 3 illustrates an exemplary virtualization environment in accordance with some embodiments.

FIG. 4 illustrates an exemplary telecommunication network connected via an intermediate network to a host computer in accordance with some embodiments.

FIG. 5 illustrates an exemplary host computer communicating via a base station with a user equipment over a partially wireless connection in accordance with some embodiments.

FIG. 6 illustrates an exemplary method implemented in a communication system including a host computer, a base station, and a user equipment in accordance with some embodiments.

FIG. 7 illustrates an exemplary computer-implemented MESyP controller configurable to interact with various service providers in accordance with some embodiments.

FIGS. 8A and 8B illustrate signal sequence diagrams between a MESyP controller, various service providers, and UEs in accordance with some embodiments.

FIG. 9 is a flowchart illustrating a method performed by a MESyP controller in accordance with some embodiments.

FIG. 10 is a flowchart illustrating a method performed by a user equipment in accordance with some embodiments.

### DETAILED DESCRIPTION

To provide a more thorough understanding of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the invention may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

Many IT departments manage their IT devices via a mobile device management (MDM) application, which is reachable from the Internet and has the capabilities to configure devices in accordance with the corporate policy by connecting to a remote database or resource (e.g., database or resource in the “Cloud”). Each operating system producer may offer its own MDM application. As described above, in order to improve visibility into remote-working users' activities, a corporate IT department often collects logs from different corporate applications. Collecting logs from different applications may not be an easy task. Furthermore, from IT department's perspective, it is desirable to have dynamic granular access control with respect to different users, different applications, different times, and different locations.

Accordingly, there currently exist certain challenge(s) to the foregoing means of obtaining visibility. Many corporate IT departments are increasingly demanding for corporate networks that can just leverage public and/or private networks with the proper security level and management capabilities (e.g., same level of visibility as when the users are working in office). Currently, there's no commercial and technical solution for such a demand. To provide a solution, several parties may need to be involved and these parties may need to implement various functionalities. For example, communication service providers may need to integrate secure access service edge (SASE) in their networks. A UE's operating system may need to support generic bootstrapping architecture and authenticated key management for application (GBA/AKMA) together with subscriber identification module (SIM), embedded subscriber identification module (eSIM), and/or integrated subscriber identification module (iSIM). In addition, the UE's operating system may need to support crypto routing tables. Some service providers such as the MDM, the MESyP controller, or others, may need to support the SASE control plane to implement corporate network policies. Moreover, the MDM systems may need to support multiple subscription manager-data preparation+ (SM-DP+) providers and communication service providers (CSPs). The SM-DP+ providers shall support GBA/AKMA in their eSIM/iSIM profiles; and an MESyP controller may need to be implemented for stitching all the previously described pieces together.

Certain aspects of the disclosure and their embodiments may provide solutions to the aforementioned challenges. In various embodiments, the devices, instruments, systems, and methods described herein may be used to facilitate cellular enabled devices (e.g., fourth generation or LTE (4G) and fifth generation (5G) enabled devices) to create a trusted and secured connectivity over public and/or private networks with a focus on secured connectivity within the cellular networks. The embodiments described herein may involve various protocols including GSMA (Groupe Speciale Mobile Association) eSIM (embedded Subscriber Identity Module) interfaces: 3GPP generic bootstrapping application (GBA): 3GPP authentication and key management for applications (AKMA); and eSIM management (e.g., based on local profile assistant or LPA).

The embodiments of the present disclosure use several novel technologies like GBA/AKMA and SASE to enable secured corporate networks by using just the public and/or private networks with an end-to-end encryption that can be centrally supervised. The embodiments of the present disclosure identify the required parties to be involved to enable the use case, the architecture required to be implemented, the involved interfaces, and the required standards or protocols. Moreover, the embodiments of the present disclosure reduce or eliminate gaps in the existing technologies.

In particular, based on various embodiments of the present disclosure, a controller (e.g., an MESyP controller) and/or an MDM system can manage GBA/AKMA servers: SM-DP+ profile orders including GBA/AKMA information: SASE instances from network providers (private or public): a VPN control plane (for each served corporate) and its crypto tables; and multiple CSPs and multiple SM-DP+ providers. Correspondingly, the UEs' operating systems support GBA/AKMA servers and the SASE control plane crypto tables. And SM-DP+ providers support GBA/AKMA information included in SM-DP+ profiles. Thus, in some embodiments of the present disclosure, the controller can manage all these components to enable a solution to the aforementioned technical challenges.

Various embodiments of the present disclosure implement technologies that are not implemented in, or are different from, existing technologies. For example, the GBA/AKMA references may be included within the eSIM/iSIM profile. Because the eSIM/iSIM profile is trusted by the GSMA authority, the eSIM/iSIM profiles can thus be trusted to include GBA/AKMA sensible information like the GBA/AKMA BSF (bootstrapping server function) URL. Under this circumstance, the following entities may be involved to support the GBA/AKMA BSF URL. For example, the MESyP controller, via its interfaces, may order the eSIM/iSIM profiles by providing also the GBA/AKMA URL. Moreover, the SM-DP+ provider, via its interfaces, may receive, from the MESyP controller, the order that includes the GBA/AKMA URL and store it in the actual profile. A UE's operating system may support the GBA/AKMA key management; and the device LPA and eSIM/iSIM may expose a new API to provide GBA/AKMA keys. These above-described functionality and interfaces may not exist in current technologies.

In some embodiments of the present disclosure, a user equipment (e.g., a user end device) may support a VPN controller. Because the UE consumes GBA/AKMA keys to download the corporate crypto keys and tables (and get the corresponding SASE instances), the UE can host a new application (e.g., a VPN control plane client) to connect to the VPN controller. This functionality may also not exist in current technologies.

In some embodiments of the present disclosure, CSPs may integrate eUPFs (enterprise user plane functions) in their networks. In various embodiments, the SASE functionality is embedded within the UPF functionality to securely manage device VPNs. As a result, the serving CSP may include a new component in its network, referred to as eUPF, to serve the corporate IT department. There may be one or many instances of eUPFs in the network of the serving CSP. Therefore, the serving CSP can provide a new interface toward the VPN controller, allowing it to manage SASE functionalities for each UE. The serving CSP can also provide a new set of APIs (application programming interfaces) toward the MESyP controller to allow it to make an inventory of the available SASE instances and allow the MESyP controller to configure the proper SASE instance to the VPN controller. Such functionality and interfaces may also not exist in current technologies.

Various embodiments of the present disclosure may provide one or more of the following technical advantage(s). First, users (e.g., employees) do not need to use QR codes to manage eSIM profiles, because the eSIM profile QR code is managed by the related MDM at the bootstrap and operation stage. Second, users do not need to copy/paste any corporate certificate, nor add or select the proper SASE configuration, because the basic certificates are derived from the GBA/AKMA certificates and used to instantiate the VPN toward SASE and all the required applications. Third, the traffic from and to UEs is completely regulated by the VPN control plane component, which can be configured by the corporate IT department with the proper crypto routing tables. As a result, corporate IT departments can obtain control of all device traffic rules with high granularity.

Some of the embodiments contemplated herein will now be described more fully with reference to the accompanying drawings. Embodiments are provided by way of examples to convey the scope of the subject matter to those skilled in the art. It should also be appreciated that the following specification is not intended as an extensive overview, and as such, concepts may be simplified in the interests of clarity and brevity.

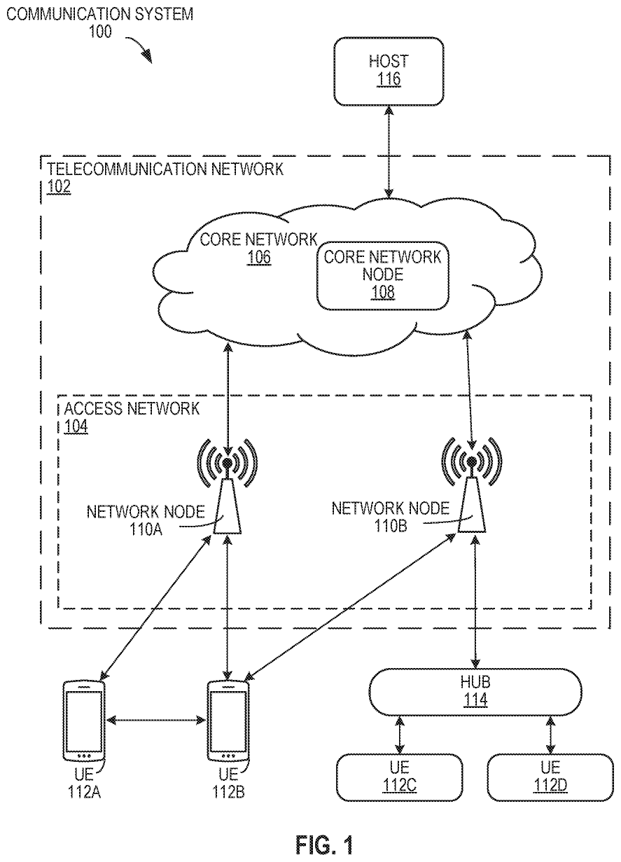

Although the subject matter described herein may be implemented in any appropriate type of system using any suitable components, the embodiments disclosed herein are described in relation to a wireless network, such as the example wireless network illustrated in FIG. 1.

FIG. 1 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G, 3G, 4G, 5G standards, or any applicable future generation standard (e.g., 6G): wireless local area network (WLAN) standards, such as the Institute of Electrical and Electronics Engineers (IEEE) 802.11 standards (Wi-Fi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (cMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

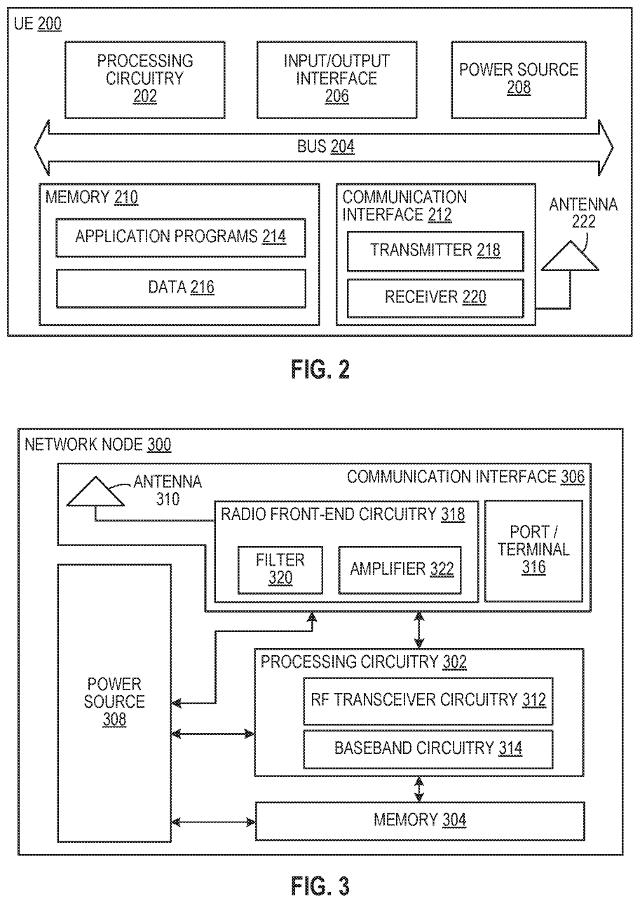

FIG. 2 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.): programmable logic together with appropriate firmware: one or more stored computer programs, general-purpose processors, such as a microprocessor or digital signal processor (DSP), together with appropriate software: or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed.

The first and/or the second UE can also include more than one of the functionalities described above. For example, a UE might comprise the sensor and the actuator, and handle communication of data for both the speed sensor and the actuators.

FIG. 3 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 3 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

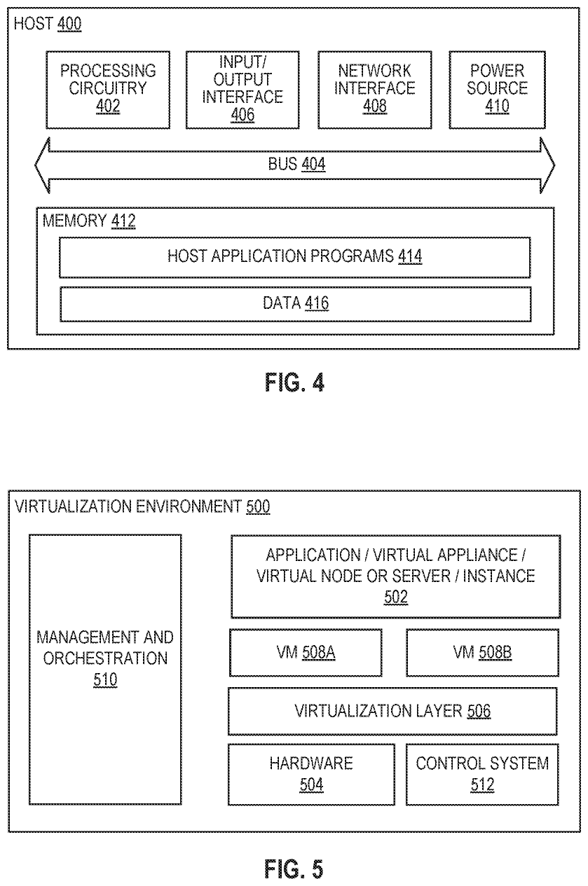

FIG. 4 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g., such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

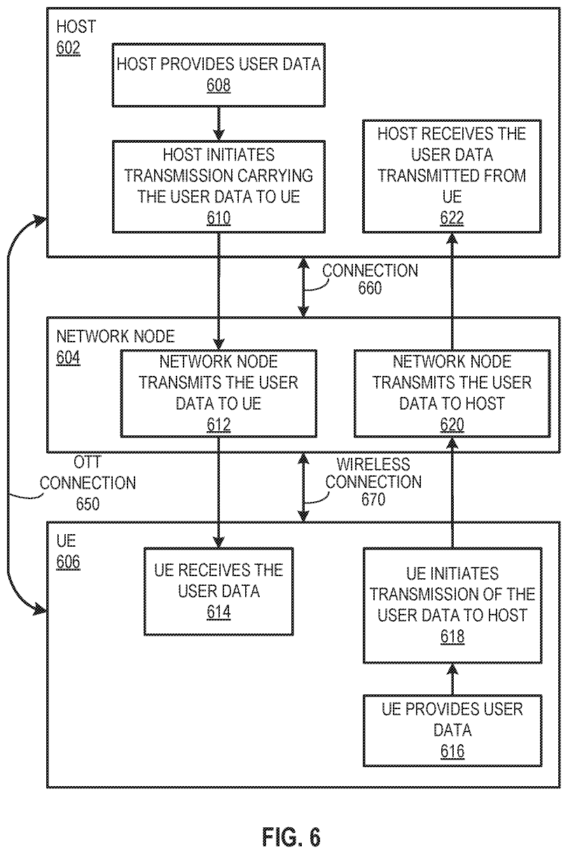

FIG. 6 shows a communication diagram of a host 602 communicating via a network node 604 with a UE 606 over a partially wireless connection in accordance with some embodiments. Example implementations, in accordance with various embodiments, of the UE (such as a UE 112a of FIG. 1 and/or UE 200 of FIG. 2), network node (such as network node 110a of FIG. 1 and/or network node 300 of FIG. 3), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes: the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.: the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

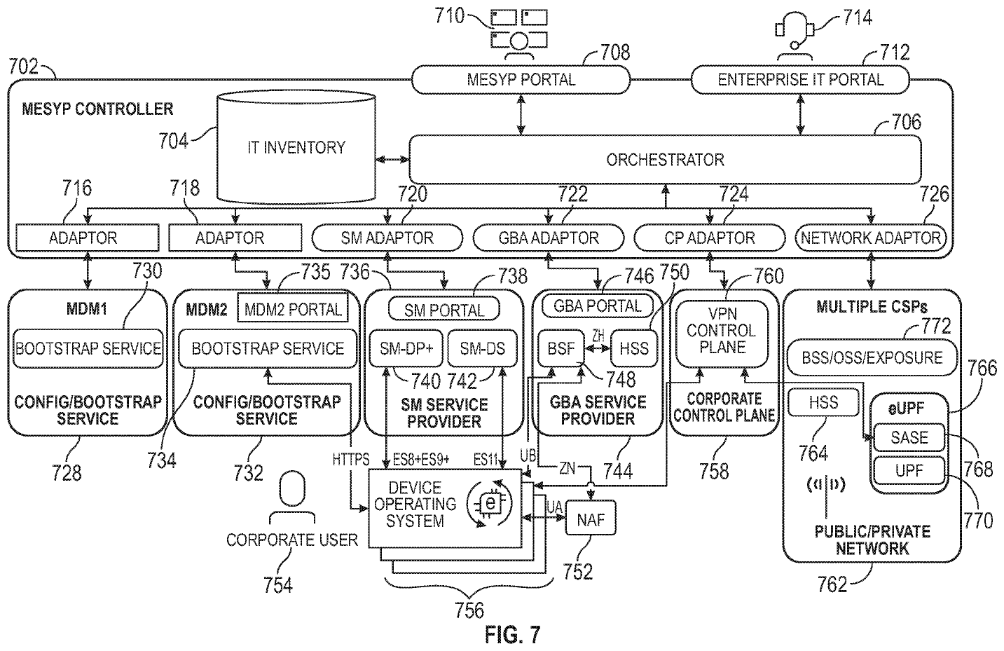

FIG. 7 illustrates an example controller 702 that arranges or combines several services including, for example, GBA/AKMA, SASE, SM-DP+, bootstrap and configuration service, etc. Controller 702 is also referred to as a MESyP controller 702. As shown in FIG. 7, in some embodiments, controller 702 includes an orchestrator 706, north bound interfaces (NBI), south bound interfaces (SBI), and IT inventory 704. Orchestrator 706 can communicate with the NBI, the SBI, and the IT inventory 704 to arrange or combine one or more aforementioned services to achieve desired effects or functionalities. In some embodiments, the NBI includes MESyP portal 708 and enterprise IT portal 712. The SBI includes one or more adaptors 716 and 718 for interfacing with bootstrap and configuration services 728 and 732. The SBI may further include an SM adaptor 720 for interfacing with SM service provider 736. The SBI may further include a GBA adapter 722 for interfacing with GBA service provider 744. The SBI may further include a CP adaptor 724 for interfacing with a corporate control plane 758. The SBI may further include a network adaptor 726 for interfacing with public and/or private networks 762.

As shown in FIG. 7, users of an MESyP controller 702 may include an MESyP operational team 710 and an enterprise IT portal client 714. MESyP operational team 710 may include one or more corporate IT users whose devices interact with the MESyP portal 708. The MESyP portal 708 provides a user interface, through which the MESyP controller 702 can provide one or more of the following services in response to one or more requests from the devices of the corporate IT users. For example, in response to a request received by portal 708, orchestrator 706 of controller 702 can be configured to perform various operations as described below. While the below described operations can be based on requests or interactions received via portal 708, it is understood that orchestrator 706 can be configured to perform operations based on certain internal rules or policies and may not require a request to be received by portal 708.

As one example, via portal 708, orchestrator 706 of controller 702 can be configured to add, delete, read, and/or update corporate users' identities in an internal identity manager. The internal identity manager may store the corporate users' identities in IT inventory 704. Alternatively, corporate users' identities can be managed by an external identity manager (e.g., a remote cloud-based database that is accessible by controller 702).

As another example, via portal 708, orchestrator 706 of controller 702 can be configured to add, delete, read, and/or update corporate devices (including the devices' IDs and serial numbers): to add, delete, read, and/or update eSIM profile codes to be configured to specific devices; and/or to add, delete, read, and/or update configuration-bootstrapping service accounts. For example, each corporate device can be managed by such a service to centrally push the desired device configuration. Moreover, this service can also be used to monitor devices (e.g., to check software compliance). Depending on the corporate IT preferences, corporate devices can be managed by different device providers such as different device manufacturers. The device manufacturers may operate different MDMs.

In some embodiments, via portal 708, orchestrator 706 of controller 702 can be configured to add, delete, read, and/or update SM-DP+ provider accounts. SM-DP+ services can be provided by several providers. This capability allows controller 702 to interact with different SM-DP+ providers (e.g., provider 736) to manage eSIM profiles. Interacting with an SM service provider is described in more detail below.

As another example, via portal 708, orchestrator 706 of controller 702 can be configured to request and/or revoke eSIM profiles and to provision GBA/AKMA service profiles. Orchestrator 706 of controller 702 can also be configured to add, delete, read, and/or update CSP accounts. Depending on corporate IT preferences and on service offers, each corporate can decide to be served by one or multiple CSPs. These CSPs may provide their services via a BSS (business support system), an OSS (operation support system), or some other kind of an exposure layer.

In some embodiments, via portal 708, orchestrator 706 of controller 702 can be configured to perform lifecycle activities related to controller 702's setup. These lifecycle activities may include, for example, backup the system, restore the system, upgrade the systems, or the like.

With continued reference to FIG. 7, enterprise IT portal 712 can be configured to provide operations that are not delegated or are partially delegated to MESyP portal 708. Such operations may include, for example, monitoring UEs and their users such as their compliance status and/or traffic usage. The operations may also include configuring crypto tables, keys, and rules. Crypto tables are used to configure users' application authorization data for indicating, e.g., which user can access which corporate application(s). Controller 702 thus enables IT departments to not only establish an end-to-end encryption from UEs to the corporate networks, but also to configure which corporate applications can be accessed by each UE.

With reference still to FIG. 7, controller 702 has a south bound interface (SBI) that includes one or more adaptors 716, 718, 720, 722, 724, and 726. These adaptors can be standard and/or proprietary interfaces that are configured to interact with the involved service providers. For example, adaptors 716 and 718 can be configured to interact with an MDM1 application that is provided by a configuration/bootstrap service provider 728 and an MDM2 application that is provided by a configuration/bootstrap service provider 732, respectively. For example, service provider 728 can provide bootstrap service 730 to controller 702 by interacting directly with adaptor 716 (e.g., sending device configurations in response to a request from controller 702). As another example, service provider 732 can provide bootstrap service 734 to controller 702 by interacting with adaptor 718 through an MDM2 portal 735. For instance, controller 702, via adaptor 718, may send a request for desired device configurations to MDM2 portal 735 of service provider 732. Service provider 732, via MDM2 portal 735, can respond to adaptor 718, with the requested device configurations.

As shown in FIG. 7, bootstrap service 734 of service provider 732 can also communicate with one or more UEs 756 via, e.g., an HTTPS protocol (hypertext transfer protocol secure). For example, when a particular UE 756 connects to a network, it sends a request to bootstrap service 734 of service provider 732 to obtain bootstrap configurations. The bootstrap service 734 can then send the bootstrap configurations to the device operating system of a particular UE 736. Depending on the types of UEs 756 (e.g., the types of managed enterprise devices) and their operating systems, there can be several different service providers to manage the devices' startup procedures and their configurations, or MDMs.

FIG. 7 also illustrates that controller 702 includes an SM adaptor 720, which can be configured to interact with an SM service provider 736, or multiple SM service providers. SM service provider 736 is a subscription manager service provider (or an SM-DP+ service provider). The SM or SM-DP+ service is a GSMA trusted service that can push eSIM/iSIM profiles into eSIM/iSIM microchips in UEs. As shown in FIG. 7, SM service provider 736 can provide SM-DP+ (subscription manager-data preparation+) service 740, SM-DS (subscription manager-discovery server) service 742, and SM portal 738. SM-DP+ service 740 is responsible for creation, download, remote management (e.g., enable, disable, update, delete), and protection of a network operator's profile. The network operator's profile comprises the operator's credentials and optionally the operator's or third-party's SIM based applications. Using a wireless network, profiles can be remotely downloaded into, for example, an embedded SIM (eSIM) of UE 756. In some embodiments, UE 756 has an LPA (local profile assistant) to provide the capability of downloading encrypted profiles to the eSIM. SM-DS service 742 enables SM-DP+ service 740 to reach the eSIMs of UEs 756 without having to know which network UEs 756 are connected to.

SM-DS service 742 allows SM-DP+ service 740 to post alerts to a secure noticeboard and for UEs 756 to extract those alerts. It is used to notify the LPA when the profile data are available for download to the eSIM. Notifications are sent from SM-DP+ service 740 to SM-DS service 742. The LPA in a UE 756 polls the SM-DS for notifications when required. In some embodiments, SM service provider 736 can support GBA/AKMA in their eSIM/iSIM profiles. For example, an SM-DP+ profile order may include GBA/AKMA information.

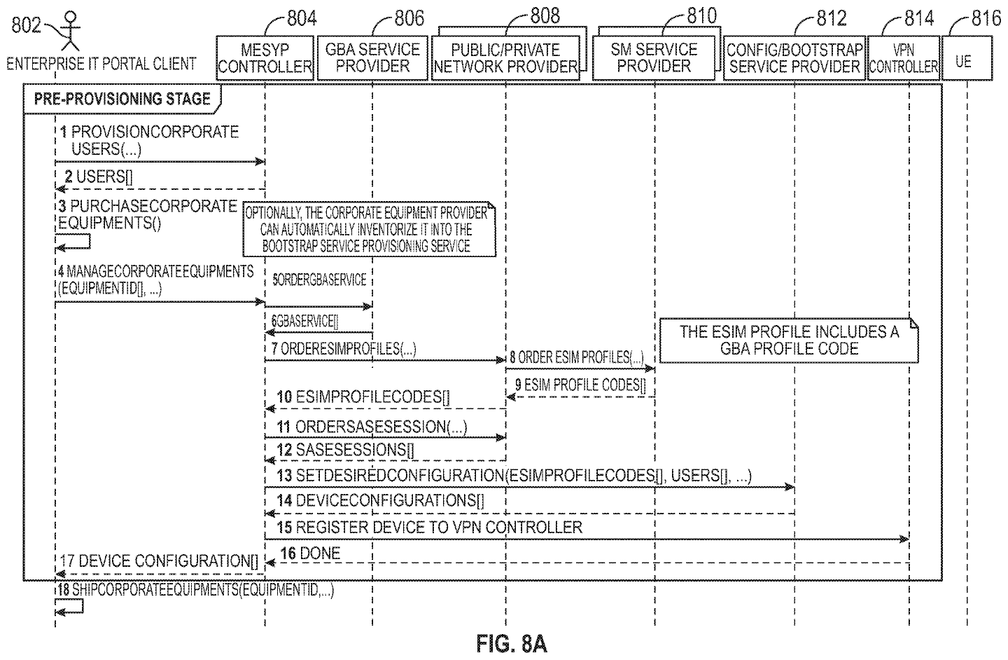

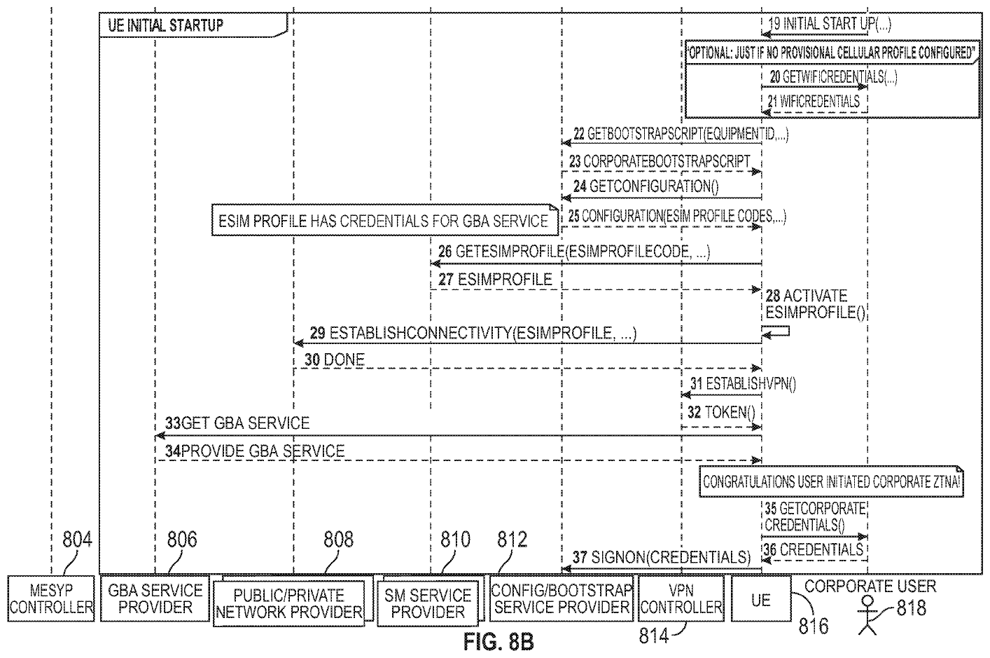

With reference still to FIG. 7, in some embodiments, controller 702 includes a GBA adaptor 722 that is configured to interact with a GBA service provider 744 via, for example, GBA portal 746. The interaction between controller 702 and GBA service provide 744 are described in more detail below using the signal sequence diagrams FIGS. 8A and 8B. In this disclosure, the term “GBA” is used interchangeably with “GBA and/or AKMA” or “GBA/AKMA”. That is, the term “GBA” is used for simplicity, but it may also include AKMA. For example, GBA service provider 744 may also be referred to as GBA/AKMA service provider 744. A GBA service is a service that manages a BSF (bootstrapping server function) 748 in accordance with the GBA standard. BSF 748 may interact with a home subscriber server (HSS) 750 via a Zh interface based on the Diameter protocol. The Zh interface is an interface enabling BSF 748 to fetch the Authentication Vectors (Credentials) and user's security setting (GUSS) from the HSS. In some examples, a first secured connection is required to be established from a UE 756 to its corresponding enhanced user plane function (CUPF). An example E-UPF 766 is located in a public and/or private network 762 as shown in FIG. 7.

A UPF (e.g., UPF 770) is the function that connects the actual data coming over the radio area network (RAN) to the Internet. Enhanced user plane function (E-UPF) 766 may combine functionalities of UPF 770 with functionalities of an SASE instance 768. In some embodiments, UPF 770 may support minimalistic functionalities regarding security (e.g., deep packet inspection), but it may not have sophisticated firewall or virtual private network (VPN) gateway (GW) functionalities. By combining functionalities of SASE instance 768 with the UPF 770, these extra security functionalities may become part of an enhanced UPF (CUPF) 766. Further, in some embodiments, a GBA/AKMA platform may be integrated with the SASE functionalities. For example, a computer-implemented controller may be used to implement the SASE instance. The controller may combine at least some functionalities of SASE instance 768 with the functionalities of the UPF 770. SASE instance 768 may use key exchange with a UE 756 and/or the certain applications in an enterprise network to establish secure communications. In some embodiments of the present disclosure, GBA/AKMA provided by GBA service provider 744 may be used to compute and distribute the shared keys.

As shown in FIG. 7, GBA service provider 744 may interact with an NAF (network application function) 752 via a Zn interface. NAF 752 is the network application function that is defined the GBA standard. When GBA is used, UE 756 and BSF 748 can mutually authenticate via a 3GPP protocol. Additionally, BSF 748 sends related queries to HSS 750 via, for example, a Zh interface. Afterwards, UE 756 and BSF 748 agree on a session key to be used for exchanging encrypted data with the application server (NAF 752). When UE 756 again connects to NAF 752 (e.g., via a (Ja interface), NAF 752 is able to obtain the session key as well as user-specific data from BSF 748 and can start data exchange with UE 756, using the related session keys for encryption. UE 756 can communicate with BSF 748 via a Ub interface.

With reference still to FIG. 7, in some examples, controller 702 includes a control plane (CP) adaptor 724 configured to interact with corporate control plane 758, which provides a VPN control plane 760. In some examples, a UE 756 can get configurations (e.g., crypto-routing table and SASE/SSE's IP addresses) from VPN control plane 760. VPN control plane 760 can be located in, or provided by, a telecommunication equipment provider's backend server. As shown in FIG. 7, VPN control plane 760 can facilitate establishing a VPN (e.g., a GBA/AKMA based VPN) between a UE 756 and SASE instance 768 of cUPF 766 in public/private network 762. Corporate control plane 758 may interact with controller 702 via, for example, CP adaptor 724. As described in more detail below, using CP adaptor 724, controller 702 can register a UE to VPN control plane 760 (corresponding to VPN controller 814 shown in FIG. 8A).

FIG. 7 further illustrates that controller 702 includes a network adaptor 726 configured to interact with multiple CSPs that provide one or more public and/or private networks. The one or more public network and/or private networks are collectively referred to as public/private network 762. Public/private network 762 is responsible to provide cellular (e.g., 4G, 5G, or any other generations) connectivity from an RAN to the packet core including at least one SASE service. SASE is a network architecture that combines WAN (wide area network) capabilities with cloud-native security functions like secure web gateways, cloud access security brokers, firewalls, zero-trust network access, or the like. These functions are provided as a service by an SASE service provider. In some examples, the SASE functionality is embedded within the UPF functionality to securely manage device VPNs (e.g., as described above, cUPF 766 combines functionalities of SASE instance 768 and functionalities of UPF 770). Thus, the serving CSP includes eUPF 766 to serve the corporate IT departments. While FIG. 7 only show one eUPF 766, it is understood that there may be many instances of eUPFs. The serving CSP can provide an interface toward VPN control plane 760, allowing it to manage SASE functionalities for each UE 756. The serving CSP can also provide a new set of APIs (application programming interfaces) toward controller 702 to allow it to make inventory of the available SASE instances and allow controller 702 to configure the proper SASE instance to VPN control plane 760.

As also shown in FIG. 7, CSPs may also provide their services via a BSS, an OSS, or some other kind of an exposure layer 772. In some examples, CSPs also provide services using HSS 764.

As described above, controller 702 can be configured to interact with various service providers via respective adaptors 716, 718, 720, 722, 724, and 726 in the southbound interfaces. The various adaptors 716, 718, 720, 722, 724, and 726 can interact with orchestrator 706. Data, configurations, and requests can be passed between orchestrator 706 and the adaptors. In some examples, controller 702 can implement the exposed functionalities of the various services by leveraging an inventory system 704 to manage not only the connected services via the SBI but also the information that they should exchange with each other to accomplish their final targets. For example, the components related to controller 702 include UEs such as managed enterprise devices (MEDs), eSIM (or iSIM) profiles, keys and rules, etc. The MEDs are devices that may connect to a zero-trusted network. The eSIM (or iSIM) profiles are profiles that are loaded into the MEDs to connect to the zero-trusted network. The keys and rules are to configure crypto-routing tables on an SASE instance.

As shown in FIG. 7, each of the SBI connected service providers can be connected via an adapter (optional) to prevent controller 702 from being dependent on their interface model.

FIGS. 8A and 8B illustrate signal sequence diagrams between controller 804, various service providers 806, 808, 810, 812, and 814, and UE 816 in accordance with some embodiments. It is understood that UE 816 is a device for illustration only, and the below description of the sequence diagrams can be applied to multiple UEs. As described in more detail below, FIG. 8A illustrates a first stage where the enterprise IT portal client 802 interacts with controller 804 to configure UEs (e.g., corporate devices). The first stage is also referred to as the pre-provisioning stage, which includes steps 1 to 18 as shown in FIG. 8A. FIG. 8B illustrates a second stage where the UEs connect to the network after the pre-provisioning stage. The second stage is also referred to as the UE startup stage, which includes steps 19 to 37. In some embodiments, there may be another phase, e.g., the operational phase, where the enterprise IT portal client 802 can change and monitor corporate devices or just change the current setup.

In FIGS. 8A and 8B, enterprise IT portal client 802, controller 804, GBA service provider 806, public/private network provider 808, SM service provider 810, configuration and bootstrap service provider 812, VPN controller 814, and UE 816 can be substantially the same as enterprise IT portal client 714, controller 702, GBA service provider 744, CSPs of public/private network 762, SM service provider 736, configuration and bootstrap service provider 732, VPN control plane 760, and UE 756, respectively, and are therefore not repeatedly described.

The various elements shown in sequence diagrams shown in FIGS. 8A and 8B can be a single element or multiple elements. For example, public/private network provider 808 and SM service provider 810 can each be a single provider or multiple providers. Similarly, UE 816 can be single UE or multiple UEs.

With reference to FIG. 8A, in the pre-provisioning stage (first stage), the process may begin with step 1, where enterprise IT portal client 802 (e.g., a user in the corporate IT department) may use a device to interact with controller 804 via an enterprise IT portal (e.g., portal 712) for obtaining user-related data in the system. Such users may be, for example, new employees or colleagues of the corporate organization. The process associated with obtaining user-related data is sometimes also referred to as provisioning users. In this user provisioning process, a user's device (e.g., a laptop computer) may be acquired. The user's device may receive initial inputs that enable it to fetch needed configurations and parameters. A username and a password for the user may also be set up so that the user can log in to the device and to the corporate network. In step 1 shown in FIG. 8A, enterprise IT portal client 802, via a device, may send a request to controller 804 to obtain user-related data. In step 2, controller 804 outputs a set of user identifiers (e.g., names, employee IDs, etc.) and other user attributes (e.g., title, department, type of devices required, etc.) and may optionally send them back to the device used by enterprise IT portal client 802.

In step 3 of the process shown in FIG. 8A, enterprise IT portal client 802 can pre-order equipment (e.g., mobile devices) or reactively purchase equipment for the new users. Each equipment has its own identifier for its internal components. For example, a laptop has its own serial number: its internal Wi-Fi card has its own MAC address: its internal cellular modem has its own IMEI identifier: or the like. In some embodiments, step 3 may optionally include registering identifies. All these identifiers can be registered as part of the device inventory (e.g., an inventory included in controller 804 and/or the configuration and bootstrap service provider 812).

In step 4 of the process, based on the previous data from the UEs (e.g., the purchased equipment), enterprise IT portal client 802, via a device, sends a request to controller 804 to manage one or more UEs.

Based on the request received from enterprise IT portal client 802, controller 804 performs the next several steps for enabling one or more UEs to establish trusted communication across a zero-trust network. In step 5 of the process shown in FIG. 8A, based on the user-related data (e.g., their roles and responsibilities), for each user, controller 804 generates a set of rules (e.g., crypto-tables) and keys (security keys) for establishing the trusted communication across the zero-trusted network. Controller 804 can exchange the rules and/or security keys with GBA service provider 806. Based on the rules and keys, GBA service provider 806 provides a set of GBA services, one per user. A GBA service, when executed, provides a set of rules and security keys for a particular user. In step 6, GBA service provider 806 sends a GBA service back to the controller 804.

Continuing with the process shown in FIG. 8A, for each UE that shall be assigned to a user, in step 7, controller 804 orders an eSIM profile by sending a request to public/private network provider 808. The eSIM profile can enable a UE to connect to a cellular network (e.g., 4G/5G/6G or any other generations). In step 8, if a SM service provider is not available within the network provider 808, network provider 808 passes the request to the SM service provider 810 with the necessary network properties (e.g., network identifiers, network encryption keys, etc.).

In step 9, SM service provider 810 sends eSIM profile references corresponding to the requested one or more eSIM profiles to network provider 808. In some embodiments, the one or more eSIM profiles includes credentials that a GBA service can use to generate additional security credentials, which can be shared with a particular NAF. In step 10, the eSIM profile references are passed on from network provider 808 to controller 804.

In step 11 of the process shown in FIG. 8A, controller 804 sends a request to network provider 808 for obtaining a reference to a set of SASE instances. A set of SASE instances may include one or many SASE instances. In some examples, network provider 808 is also responsible for the SASE service that is available in its network (e.g., an SASE service that is combined with UPF to form an CUPF as described above). In step 12, controller 804 obtains, from network provider 808, a reference to the interface of the set of SASE instances in order to configure the crypto-tables for each user if/when necessary. In the present disclosure, when the term “SASE” is used, it may also refer to, or include, SSE (Security Service Edge). SSE is a “scaled-down” version of SASE and may include less functionalities than SASE. Based on the reference to the SASE interface, a set of SASE instances are provided to controller 804.

With reference still to FIG. 8A, controller 804 builds one or more UE-specific bootstrap configurations for each UE associated with a user (e.g., UE 816), based on data collected in the previous steps (e.g., eSIM profile, GBA service, SASE instances, etc.). In step 13, controller 804 sends the UE-specific configurations built for each UE to configuration and bootstrap service provider 812. The configuration and bootstrap service provider 812 returns an indication (step 14) for indicating that the desired UE configurations are stored in its inventory system.

In some embodiments, controller 804 can also register UEs to VPN controller 814 in step 15. When registering UE to the VPN controller 814, MESyP controller 804 may send required data (e.g., device identity) to VPN controller 814, thereby enabling VPN controller 814 to recognize the UE as a safe device. In step 16, if the registration is successful, VPN controller 814 sends an indication to MESyP controller 804 to indicate that the registration is completed.

In some embodiments, the resulting UE-specific bootstrap configurations can be stored into the MESyP controller 804's inventory system and optionally returned to a device of enterprise IT portal client 802 (step 17). This interaction with the device of enterprise IT portal client 802 can be asynchronous (via order management). In step 18, the UEs (e.g., corporate devices) are distributed to the corresponding users (e.g., employees).

Turning now to FIG. 8B, which is a sequence diagram illustrating a process for establishing a secured communication channel through a zero-trusted network for one or more UEs (e.g., UE 816). In step 19, UE 816 starts up. For example, a user 818 may push the power button of UE 816 to initialize UE 816.

FIG. 8B shows two optional steps 20 and 21, which are performed if no provisional cellular profiles are configured for UE 816 (and therefore, UE 816 may need to establish some sort of connection first). In step 20, for example, UE 816 (e.g., a laptop) checks for a connected wired network. If a wired network is missing or unavailable, UE 816 checks for Wi-Fi networks. If a Wi-Fi network is available, UE 816 requests Wi-Fi credentials to connect. In step 21, user 818 provides the Wi-Fi credentials to UE 816, thereby enabling UE 816 to connect to the Wi-Fi network.

In step 22, after establishing a network connection (wired or Wi-Fi), UE 816 sends a request to configuration and bootstrap service provider 812 to obtain one or more UE-specific bootstrap configurations. As described above, MESyP controller 804 has performed one or more steps shown in FIG. 8A and sent the UE-specific configurations to configuration and bootstrap service provider 812. As a result, the UE-specific configurations for UE 816 are available at configuration and bootstrap service provider 812. Service provider 812 thus provides the UE-specific configurations to UE 816 in step 23.

Continuing the process shown in FIG. 8B, in steps 24 and 25, UE 816 executes the startup procedure by obtaining the UE-specific configurations that include the eSIM profile reference (e.g., retrieving the actual profile from the SM-DP+ service provider). In particular, in step 24, UE 816 sends a request to configuration and bootstrap service provider 812 to obtain configurations that include the eSIM profile reference. In step 25, configuration and bootstrap service provider 812 sends the eSIM profile reference to UE 816. In some embodiments, eSIM profile reference can be used to obtain one or more eSIM profiles. As described below, UE 816 obtains the one or more eSIM profiles based on the eSIM profile reference. The one or more eSIM profiles include credentials that a GBA service can use to generate additional security credentials, which can be shared with a particular NAF. The GBA service is executed after UE 816 obtains one or more eSIM profiles.

Based on the eSIM profile reference, the eSIM of UE 816 sends (step 26) a request to SM service provider 810 and obtains (step 27) the eSIM profile from SM Service Provider 810 (e.g., from the SM-DP+ service).

Based on the eSIM profile downloaded, the eSIM of UE 816 activates the new profile (step 28). Once activated, a modem (e.g., a 4G or 5G modem) within UE 816 establishes (step 29) its connectivity with a network node of the public/private network provider 808. In some examples, network provider 808 may send an indication back to UE 816 indicating that UE 816 is connected (step 30).

In step 31, UE 816 communicates with VPN controller 814 for requesting establishing a VPN. As described above, in step 15, controller 804 may have registered UE 816 to VPN controller 814. As a result, VPN controller 814 recognizes UE 816 as a safe device and sends (step 32) one or more tokens for establishing a VPN (e.g., GBA/AKMA based VPN) between UE 816 and an SASE instance of public/private network provider 808.

In step 33, based on the credentials included in the one or more eSIM profiles obtained in a previous step, UE 816 sends a request to GBA service provider 806 to obtain the GBA service. In step 34, the GBA service is provided to UE 816. For example, the GBA service can use credentials stored on a particular eSIM profile to generate additional security credentials, which can be shared with a particular NAF. At this point, the UE 816 has established a secured connection through a zero-trusted network.

In some embodiments, UE 816 may be a corporate device. As a result, the UE-specific configurations also set an access management system that requires credentials. In this case, UE 816 may request user 818 to provide corporate credentials (step 35). Once user 818 provides the credentials (step 36) to UE 816, the credentials can be used to sign on (step 37) to the access management system. In some examples as shown in FIG. 8B, the access management system may be within the configuration and bootstrap service provider 812.

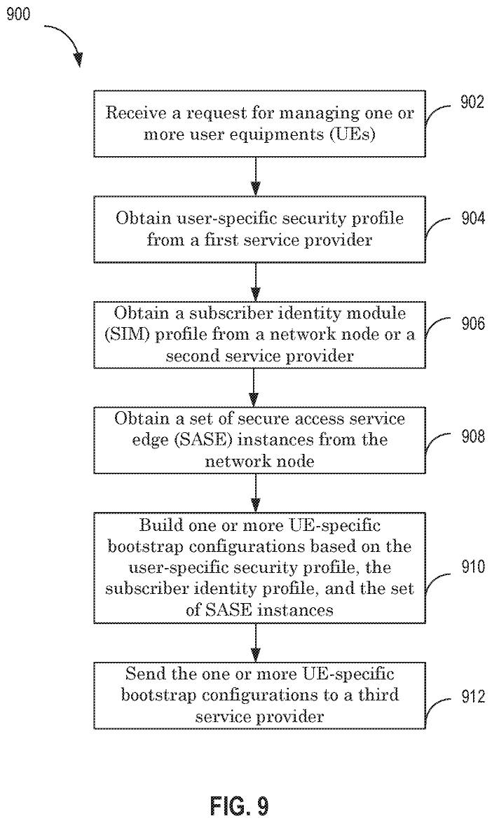

FIG. 9 is a flowchart illustrating a method 900 performed by a computer-implemented controller (e.g., controllers 702 or 804 as described above). Method 900 may begin with step 902, in which the controller receives a request for managing one or more UEs (e.g., UEs 756 or 816). For example, the request may be sent from an enterprise IT portal client (e.g., portal client 714 or 802) to the controller.

In some embodiments, the controller obtains one or more identifiers associated with one or more components of one or more UEs. As described above, the one or more identifiers may include mobile device serial numbers, internal Wi-Fi card MAC address, IMEI identifiers, etc. These identifiers can be registered as part of the device inventory included in the controller and/or a configuration and bootstrap service provider. For example, the controller stores the one or more identifiers in a device inventory of the controller. The controller may also send the one or more identifiers to a service provider such as the configuration and bootstrap service provider (e.g., an MDM service provider).

In step 904 of method 900, the controller obtains a user-specific security profile from a first service provider. For instance, the controller generates a set of user-specific rules (e.g., the crypto-tables) and exchanges security keys with the first service provider (e.g., a GBA service provider). The first service provider may output a set of user-specific security profiles (e.g., provided by a GBA service). The user-specific security profile includes the set of user-specific rules and the security keys. The user-specific security profile is configured to facilitate a configuration and bootstrap service provider to authenticate a UE.

In step 906 of method 900, the controller obtains a SIM profile from a network node or another service provider. For example, the controller sends a request to the network node of a public and/or private network to obtain the SIM profile, and receives the SIM profile from the network node. The SIM profile is configured to facilitate a UE to establish a cellular communication. In some embodiments, the SIM profile may not be available at the network node. In this case, the network node obtains the SIM profile from an SM service provider and provides the obtained SIM profile to the controller via the network node.

In step 908 of method 900, the controller obtains a set of SASE instances from the network node. For instance, the controller can obtain a reference to an SASE interface, and receive the set of SASE instances based on the reference to the SASE interface. The set of SASE instances may be received from a network node of a network provider. In some examples, the controller configures a set of user-specific rules based on the set of SASE instances. The user-specific rules can be the crypto-tables.

In step 910 of method 900, the controller builds one or more UE-specific bootstrap configurations based on the user-specific security profile, the SIM profile, and the set of SASE instances.

In step 912 of method 900, the controller sends the UE-specific bootstrap configurations to a configuration and bootstrap service provider. The one or more UE-specific bootstrap configurations are obtainable by one or more UEs to establish a secured wireless communication channel through a zero-trusted network. In some examples, the controller stores the UE-specific bootstrap configurations in a device inventory of the controller. The controller can also provide a representation of the UE-specific bootstrap configurations to an MDM service provider for storage, and receive a confirmation from the MDM service provider that the one or more UE-specific bootstrap configurations is stored. The MDM service may be provided by the configuration and bootstrap service provider.

In some examples, method 900 may further include a step (not shown) in which the controller sends a request for registering one or more UEs with a virtual private network (VPN) controller; and receives a confirmation from the VPN controller that the one or more UEs are registered. This way, the VPN controller will recognize the UEs as safe devices.

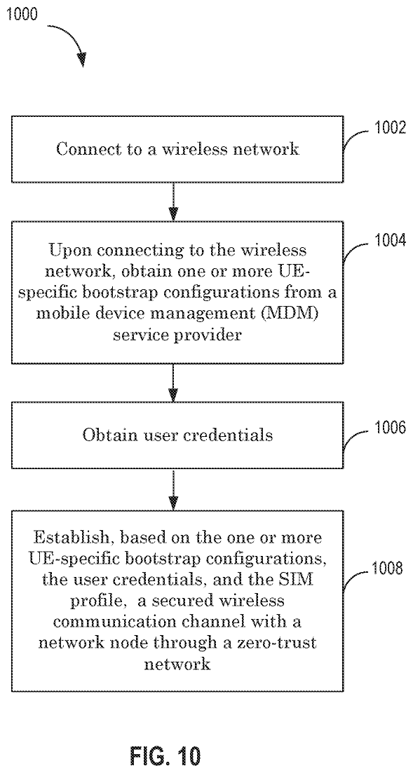

FIG. 10 illustrates a flowchart of a method 1000 performed by a UE. Method 1000 is an example flow performed by the UE to support GBA/AKMA and VPN control plane. As shown in FIG. 10, in step 1002, the UE connects to a wireless network. For instance, the UE may request for connectivity to a wireless network (e.g., a Wi-Fi network). The UE can also connect to a wired network using an Ethernet cable.

In step 1004, upon connecting to the wireless network, the UE obtains one or more UE-specific bootstrap configurations from a mobile device management (MDM) service provider. The MDM service provider can be a bootstrap and configuration service provider. For example, upon connecting, the UE sends a request to the MDM service provider. The MDM service provider may forward the UE's connection request to a Single Sign On URL. When the UE is signed in, the UE obtains its UE-specific bootstrap configurations from the MDM server of the service provider. The particular MDM service provider is specific to the user and the corporate that the user is associated with.

As described above, the one or more UE-specific bootstrap configurations can be generated based on a user-specific security profile, a subscriber identity module (SIM) profile, and a set of SASE instances. The UE-specific bootstrap configurations comprise one or more configurations associated with eSIM profile codes (that includes GBA/AKMA URL in the future); one or more of a VPN controller URL and optionally a VPN controller certificate for improved security: disabling a physical SIM: selecting a primary eSIM profile (e.g., based on the current location): disabling adding new eSIM profiles: enabling capability of switching eSIM profiles; and/or not selecting 5G as primary connection yet.

With reference still to FIG. 10, in step 1006, the UE may obtain user credentials. As described above, in some cases, the users are corporate users and therefore corporate user credentials are required for logging into the access management system.

In step 1008, the UE establishes, based on the one or more UE-specific bootstrap configurations, the user credentials, and the SIM profile, a secured wireless communication channel with a network node through a zero-trusted network. For example, based on an eSIM/iSIM reference configuration included in the UE-specific bootstrap configuration, the LPA of the UE obtains the SM-DP+ profile code (URL+ID) and downloads the corresponding eSIM/iSIM profiles. When an eSIM/iSIM profile is loaded into the UE, the UE activates a cellular network (e.g., a 5G network) based on the eSIM//iSIM profile. In some examples, the data traffic may continue to flow through the Wi-Fi connection. Thus, the cellular network activated may be different from the wireless network the UE initially connected to.

In some embodiments, a VPN client, which operates in the UE OS, connects to VPN controller and obtains the crypto keys, tables, and the SASE IP addresses (for both cellular and Wi-Fi networks) (mutual TLS authentication). As described above in connection with the previous sequence diagrams, the VPN controller already configured one or more SASE instances for the UE. As a result, the UE can establish a VPN to the related SASE instances. If a cellular network is reachable, the VPN client connects to eUPF in a network node over the cellular connection (the SASE side) via the VPN based on the previous crypto keys. If a cellular network is not reachable, the VPN client connects to the SASE IP that was set for Wi-Fi connection (it could be the same if CSPs agree on exposing the SASE server to Internet).

In some embodiments, all Wi-Fi connectivity may be deprioritized except for the corporate Wi-Fi. And the corporate Wi-Fi over the cellular network is prioritized. If the coverage is not good, users can manually switch the eSIM profile (or the system can check the coverage map and select the best eSIM profile accordingly, or the IT department can order the switch via its portal).

In addition, the GBA/AKMA keys that the device operating system obtained in the previous sequence can be refreshed on demand. This action is triggered on a timeout base or from the MESyP controller NBI. When it is required to refresh keys, the MESyP controller, via MDM, sends a request to the UE to refresh it and the UE's operating system requests a new key from the eSIM.

In some embodiments, both the MESyP controller and the MDM service are deployed in a cloud that is reachable from the Internet, at the global level, thereby enabling managing corporations in different countries via different CSPs.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various 10 modifications may be implemented by those skilled in the art without departing from the scope and spirit of the invention. Those skilled in the art could implement various other feature combinations without departing from the scope and spirit of the invention.

1. A method performed by a computer-implemented controller, the method comprising:
receiving a request for managing one or more user equipments (UEs);
obtaining a user-specific security profile from a first service provider;
obtaining a subscriber identity module (SIM) profile from a network node or a second service provider;
obtaining a set of secure access service edge (SASE) instances from the network node;
building one or more UE-specific bootstrap configurations based on the user-specific security profile, the SIM profile, and the set of SASE instances; and
sending the one or more UE-specific bootstrap configurations to a third service provider, the one or more UE-specific bootstrap configurations being obtainable by the one or more UEs to establish a secured wireless communication channel through a zero-trusted network.

2. The method of claim 1, further comprising the steps of, for each UE of the one or more UEs:
obtaining one or more identifiers associated with one or more components of the UE;
storing the one or more identifiers in a device inventory of the controller; and
sending the one or more identifiers to the third service provider.

3. The method of claim 1, wherein obtaining the user-specific security profile from the first service provider comprise:
generating a set of user-specific rules; and
exchanging security keys with the first service provider, wherein the user-specific security profile includes the set of user-specific rules and the security keys, the user-specific security profile being configured to facilitate the third service provider to authenticate a UE of the one or more UEs.

4. The method of claim 1, wherein obtaining the SIM profile from the network provider or the second service provider comprises:
sending a request to the network node to obtain the SIM profile; and
receiving the SIM profile from the network node, wherein the SIM profile is configured to facilitate a UE of the one or more UEs to establish a cellular communication.

5. (canceled)

6. (canceled)

7. (canceled)

8. (canceled)

9. The method of claim 1, further comprising:
storing the one or more UE-specific bootstrap configurations in a device inventory of the controller;
providing a representation of the one or more UE-specific bootstrap configurations to an MDM service provider for storage; and
receiving a confirmation from the MDM service provider that the one or more UE-specific bootstrap configurations is stored.

10. The method of claim 1, further comprising:
sending a request for registering the one or more UEs with a virtual private network (VPN) controller; and
receiving a confirmation from the VPN controller that the one or more UEs are registered.

11. A method performed by a user equipment, the method comprising:
connecting to a wireless network;
upon connecting to the wireless network, obtaining one or more UE-specific bootstrap configurations from a mobile device management (MDM) service provider, the one or more UE-specific bootstrap configurations being based on a user-specific security profile, a subscriber identity module (SIM) profile, and a set of SASE instances;
obtaining user credentials; and
establishing, based on the one or more UE-specific bootstrap configurations, the user credentials, and the SIM profile, a secured wireless communication channel with a network node through a zero-trusted network.

12. The method of claim 11, wherein the one or more UE-specific bootstrap configurations comprise configurations associated with:
an embedded subscriber identification module or integrated subscriber identification module (eSIM/iSIM) profile reference;
one or more of a VPN (virtual private network) controller URL (uniform resource link) and a VPN controller certificate;
disabling a physical SIM;
selecting a primary eSIM profile;
disabling adding new eSIM profiles; and
enabling capability of switching eSIM profiles.

13. The method of claim 11, wherein establishing the secured wireless communication channel with the network node through the zero-trust network comprises:
obtaining, based on an eSIM/iSIM reference configuration included in the one or more UE-specific bootstrap configurations, an eSIM/iSIM profile from a service manager (SM) service provider; and
activating the UE to connect to a cellular network based on the eSIM/iSIM profile.

14. (canceled)

15. The method of claim 13, further comprising the steps of:
connecting to at least one of a generic bootstrapping architecture (GBA) service provider or an authenticated key management for application (AKMA) service provider to obtain one or more cryptograph keys;
connecting, via a virtual private network (VPN) client of the UE, to a VPN controller to obtain a set of user-specific rules, cryptograph keys, and SASE IP addresses; and
establishing a VPN connection between the UE and one or more SASE instances based on the set of user-specific rules, the one or more cryptograph keys, and the SASE IP addresses.

16. The method of claim 15, wherein establishing a VPN connection between the UE and one or more SASE instances comprises:
in accordance with a determination that the UE is connected to the cellular network, establishing the VPN connection to the one or more SASE instances based on the cryptograph keys; and
in accordance with a determination that the UE is not connected to the cellular network, establishing the VPN connection to the one or more SASE instances based on the SASE IP addresses configured for the wireless network.

17. A computer-implemented controller for managing a mobile embedded security platform, the controller comprising:
a transceiver, a processor and a memory, said memory containing instructions executable by said processor whereby said controller is operative to perform:
obtaining a user-specific security profile from a first service provider;
obtaining a subscriber identity module (SIM) profile from a network node or a second service provider;
obtaining a set of secure access service edge (SASE) instances from the network node;
building one or more UE-specific bootstrap configurations based on the user-specific security profile, the SIM profile, and the set of SASE instances; and
sending the one or more UE-specific bootstrap configurations to a third service provider, the one or more UE-specific bootstrap configurations being obtainable by the one or more UEs to establish a secured wireless communication channel through a zero-trusted network.

18. The computer-implemented controller of claim 17, further operative to perform the steps of, for each UE of the one or more UEs:
obtaining one or more identifiers associated with one or more components of the UE;
storing the one or more identifiers in a device inventory of the controller; and
sending the one or more identifiers to the third service provider.

19. The computer-implemented controller of claim 17, wherein obtaining the user-specific security profile from the first service provider comprises:
generating a set of user-specific rules; and
exchanging security keys with the first service provider, wherein the user-specific security profile includes the set of user-specific rules and the security keys, the user-specific security profile being configured to facilitate the third service provider to authenticate a UE of the one or more UEs.

20. (canceled)

21. (canceled)

22. (canceled)

23. (canceled)

24. (canceled)

25. The computer-implemented controller of claim 17, further operative to perform:
storing the one or more UE-specific bootstrap configurations in a device inventory of the controller;
providing a representation of the one or more UE-specific bootstrap configurations to an MDM service provider for storage; and
receiving a confirmation from the MDM service provider that the one or more UE-specific bootstrap configurations is stored.

26. (canceled)

27. A user equipment (UE) for establishing a secured connection based on a mobile embedded security platform, comprising:
a transceiver, a processor, and a memory, said memory containing instructions executable by the processor whereby the UE is operative to perform:
connecting to a wireless network;
upon connecting to the wireless network, obtaining one or more UE-specific bootstrap configurations from a mobile device management (MDM) service provider, the one or more UE-specific bootstrap configurations being based on a user-specific security profile, a subscriber identity module (SIM) profile, and a set of SASE instances;
obtaining user credentials; and
establishing, based on the one or more UE-specific bootstrap configurations, the user credentials, and the SIM profile, a secured wireless communication channel with a network node through a zero-trusted network.

28. The UE of claim 27, wherein the one or more UE-specific bootstrap configurations comprise configurations associated with:
an embedded subscriber identification module or integrated subscriber identification module (eSIM/iSIM) profile reference;
one or more of a VPN (virtual private network) controller URL (uniform resource link) and a VPN controller certificate;
disabling a physical SIM;
selecting a primary eSIM profile;
disabling adding new eSIM profiles; and
enabling capability of switching eSIM profiles.

29. The UE of claim 27, wherein establishing the secured wireless communication channel with the network node through the zero-trust network comprises:
obtaining, based on an eSIM/iSIM reference configuration included in the one or more UE-specific bootstrap configurations, an eSIM/iSIM profile from a service manager (SM) service provider; and
activating the UE to connect to a cellular network based on the eSIM/iSIM profile.

30. (canceled)

31. The UE of claim 29, further operative to perform the steps of:
connecting to at least one of a generic bootstrapping architecture (GBA) service provider or an authenticated key management for application (AKMA) service provider to obtain one or more cryptograph keys;
connecting, via a virtual private network (VPN) client of the UE, to a VPN controller to obtain a set of user-specific rules, cryptograph keys, and SASE IP addresses; and
establishing a VPN connection between the UE and one or more SASE instances based on the set of user-specific rules, the one or more cryptograph keys, and the SASE IP addresses.

32. The UE of claim 31, wherein establishing a VPN connection between the UE and one or more SASE instances comprises:
in accordance with a determination that the UE is connected to the cellular network, establishing the VPN connection to the one or more SASE instances based on the cryptograph keys; and
in accordance with a determination that the UE is not connected to the cellular network, establishing the VPN connection to the one or more SASE instances based on the SASE IP addresses configured for the wireless network.
